(19) United States
(12) Patent Application Publication
(10) Pub. No.: US 2026/0034703 A1
(43) Pub. Date: Feb. 5, 2026

(54) TABLE SAW SLED FOR CUTTING ACCURATELY SHAPED AND CONSISTENTLY SPACED APART JOINT NOTCHES ALONG AN ELONGATED WORKPIECE

(71) Applicant: John Tromboukis, Stratford, NY (US)

(72) Inventor: John Tromboukis, Stratford, NY (US)

(21) Appl. No.: 18/789,178

(22) Filed: Jul. 30, 2024

(51) Int. Cl. B27B 25/10; B27B 27/08; B27B 27/10

(52) U.S. Cl. CPC B27B 25/10; B27B 27/08; B27B 27/10

(57) ABSTRACT

A table saw sled that facilitates cutting successive identical joint notches with identical spacing along an elongated strip of material, wherein the spacing is selectively adjustable through reconfigurable elements of the table saw sled. The table saw sled mounts a table saw by providing movable frameworks and reference points via registration keys that can both retain the strip of material at a desired distance from and orientation to relative to the saw blade. The selectively movable registration keys enable the cutting of identical joint notches at identical intervals along the length of the strip of material, thereby facilitating the formation of lattice grids for Kumiko work.

### BACKGROUND OF THE INVENTION

The present invention relates to methods of and devices for accurately notching workpieces for Kumiko lattices and, more particularly, to an improved table saw sled configured so that a user of a table saw cuts accurately shaped and evenly spaced apart joint notches along a workpiece used for forming Kumiko lattice grids.

Kumiko is a Japanese technique of assembling wooden pieces without the use of nails. The technique was developed in Japan in the Asuka Era (600-700 AD). Kumiko panels track together and remain in place through pressure alone, and that pressure is achieved through meticulously calculating, cutting, and arranging interweaving joints. Thinly slit wooden pieces are grooved, punched, and mortised, and then fitted individually using a plane, saw, chisel and other tools to make fine adjustments. The result is a complex pattern that is used primarily in the creation of shoji doors and screens. Accordingly, Kumiko grids need to be made with a high level of accuracy therefore they are difficult to make.

Traditionally, Kumiko pieces are made with hand tools only, but in western society they have made new techniques to make these kinds of patterns, it involves a table saw, a sharp chisel and some do it yourself (DIY) guides. There is limited available knowledge in the field of Kumiko, however, which makes DIY versions difficult to construct and have limited uses. In fact, current DIY versions have fixed registrations for joints to reference, this greatly limits the use, style and sizes of Kumiko lattice grids the user can make; in fact, they can only make one type of grid.

As can be seen, there is a need for a table saw sled that helps a user cut successive identical joint notches with identical spacing along an elongated strip of material, wherein the spacing is selectively adjustable through reconfigurable elements of the table saw sled. The table saw sled mounts a table saw to facilitate such cutting by providing movable frameworks and reference points (of ‘registration keys’) that can both retain the strip of material at a desired distance from and orientation to relative to the saw blade. The selectively movable registration keys enable the cutting of identical joint notches at identical intervals along the length of the strip of material, thereby facilitating the formation of lattice grids for Kumiko work.

### SUMMARY OF THE INVENTION

The table saw sled embodied in the present invention is an improvement over other table saw sleds for at these the following reasons: (1) a runner along the bottom surface of the table saw sled is adjustable so that the table saw sled can operatively associate with various table saws irrespective of the fixed location of the miter track, since the runner that nests into the miter track is not moveable along a bottom surface of the table saw sled; (2) angled guide planes for establishing angled joint notches are not embedded in grooves along an upper surface of the table saw sled; (3) a front sled fence is not jointed to a front edge of the table saw sled providing a truer right angle thereto, wherein a newly added rectangular guide shuttle is ridable along a key adjustment track provided by the front sled fence; furthermore, the rectangular guide shuttle a guide plane coplanar with a guide plane of an adjacent guide block, thereby further ensuring the same repeatable cut of successive joint notches.

More generally, the table saw sled has a substrate that rides along the tabletop of a table saw, wherein the substrate provides guide blocks and adjustable registration keys that enable a user to cut joints along a workpiece at consistent spacing. The process of cutting successive notches includes bracing the workpiece, relative to the table saw blade, along a guide plane of a guide block, cutting a first joint notch, and then repositioning the work piece along the guide block/plane so that the first joint notch position onto the registration key before cutting a second joint notch. Since the distance between the registration key and the blade path saw blade, i.e., a reference distance, can be selectively fixed by moving said registration key, the user can repeat the above process to cut notch after notch at the same consistent interval.

The present invention embodies a Kumiko table saw sled having adjustable registration keys to allow the user to set a desired reference distance, between the registration key and the saw blade, depending on the Kumiko lattice grid type they want. Generally speaking there are two types of joints for Kumiko workpiece, (a) a rectangular joint with a rectangular cross section that is oriented orthogonal relative to a longitudinal axis of the workpiece, thereby facilitating the creation of rectangular lattice grids, and (b) an angled joint with an angled cross section oriented at an angle relative to the longitudinal axis of the workpiece, thereby configured for making diamond or hexagonal lattice grids.

All joints, either rectangular joint or angled joint, are cut referencing the same guide plane of a guide block because each guide block is fixed to the substrate of the table saw sled and thus the table saw blade at a predetermined angle. The table saw sled of the present invention provides an orthogonal guide block oriented at a right angle to the table saw blade and one or more angled guide block disposed at an acute angle relative to the table saw blade.

In one aspect of the present invention, an improved table saw sled for repeatedly cutting notches of a predetermined size and at a predetermined interval along a workpiece provides the following: a substrate having an upper surface and an opposing lower surface; two runner adjustment slots formed in the substrate so that each runner adjustment slot communicate the upper surface with the lower surface while extending laterally along the substrate; and a runner spanning the two runner adjustment slots adjacent the lower surface so that at each interface of the runner and the two runner adjustment slots a coupler slidably associates an end of the runner with a respective runner adjustment slot, whereby the runner is laterally movable along the lower surface so as to adjust relative to a fixed miter track of a table saw the table saw sled operatively associates with.

In another aspect of the present invention, the table saw sled further includes: two angle key adjustment tracks formed in the substrate so that each angle key adjustment tracks communicate the upper surface with the lower surface while extending laterally along the substrate; an angle guide shuttle operatively associated with the two angle key adjustment tracks so that the angle guide shuttle is selectively movable laterally along the upper surface of the substrate; an angle registration key fixed to the angle guide shuttle so that the angle registration key faces a blade path of the table saw; and two angle guide blocks disposed along the upper surface of the substrate on the other side of the blade path, wherein the two angle guide blocks are nested in two grooves, respectively, along said upper surface, whereby an angle reference distance, between the angle registration key and the blade path, is selectively lockable.

In yet another aspect of the present invention, the table saw sled further includes: a front guide fence joined to a front edge of the substrate so that a substantially portion of the front guide fence projects above the upper surface thereof; a rectangle key adjustment track formed laterally in the substantial portion; a rectangle guide shuttle slidably associated with the rectangle key adjustment track; and a rectangle registration key fixed relative to a shuttle guide plane of rectangle guide shuttle so that the rectangle registration key is selectively lockable laterally along the front guide fence, whereby a rectangle reference distance, between the rectangle registration key and the blade path, is selectively lockable.

In still yet another aspect of the present invention, the table saw sled further includes a rectangle guide block fixed to the front guide fence, wherein the rectangle guide block provides a block guide surface coplanar with the shuttle guide plane.

These and other features, aspects and advantages of the present invention will become better understood with reference to the following drawings, description, and claims.

### BRIEF DESCRIPTION OF THE DRAWINGS

FIG. 1 is a top perspective view of an exemplary embodiment of a table saw sled 10 of the present invention, shown operatively associated with a table saw 11, prior to formation of a blade channel 13 (along the path of the saw blade 11A) in the substrate of the table saw sled 10.

FIG. 2 is a top left rear perspective view of an exemplary embodiment of the table saw sled of the present invention, shown prior to formation of the blade channel 13 in the substrate of the table saw sled 10.

FIG. 3 is a detailed top perspective view of an exemplary embodiment of the present invention, prior to formation of the blade channel 13 in the substrate 30 of the table saw sled 10, illustrating the operative association between a rectangular registration key 14 and rectangular guide shuttle 44 making the rectangular registration key 14 selectively slidably along a key adjustment tracks 24A, thereby allowing a user to select a reference distance between the rectangular registration key 14 and the path of the saw blade 11A, and so defining the spacing or interval between successively cut rectangular joint notches 41, 42, etc.

FIG. 4 is a bottom perspective view of an exemplary embodiment of the present invention, prior to formation of the blade channel 13 in the substrate of the table saw sled 10, illustrating the arrangement of key adjustment tracks 24A and runner adjustment tracks 26B, and a runner 16 operatively associated with the latter.

FIG. 5 is a top perspective view of an exemplary embodiment of the present invention, shown in use cutting a second rectangular joint notch 42 into a workpiece 28 that is being urged flush against a guide plane 29 of a guide block 22. The workpiece 28 has an earlier cut first rectangular joint notch 41 that is shown seated on or associates with a first registration key 14, thereby establishing the reference distance between the first rectangular joint notch 41 and the saw blade 11A and thus predetermines the distance between the first rectangular joint notch 41 and the second rectangular joint notch 42. The saw blade 11A moves through the blade channel 13 formed in the substrate 30 (by the saw blade 11A during an initial cut therethrough).

FIG. 6 is a top perspective view of an exemplary embodiment of the present invention, shown in use cutting a second angled joint notch 52, wherein a first angled joint notch 51 is seated on a second registration key 15, while urged against a guide plane of the angled guide block 22, thereby predictably establishing a predetermined spacing between adjacent angled joint notches, wherein each angled joint notch has the same angled cross section.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

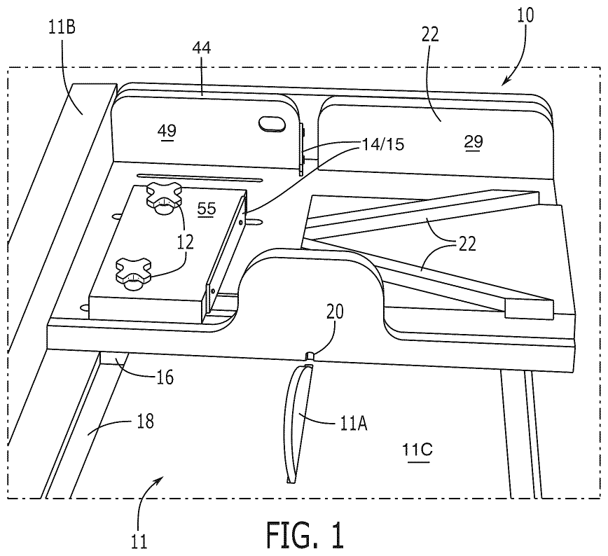

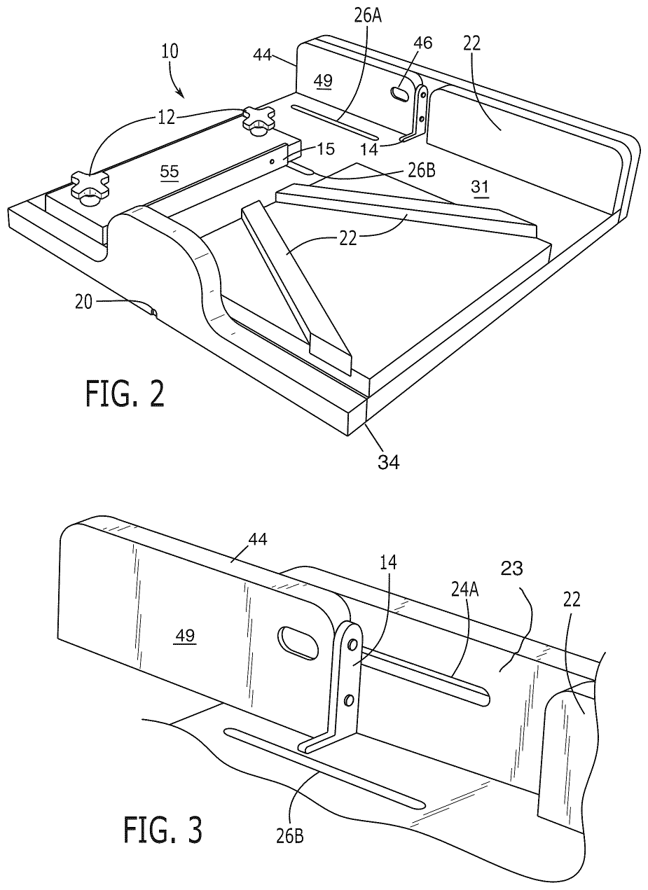

Referring to FIGS. 1 through 6, the present invention provides a table saw sled 10 for defining an easily repeatable joint notch sized spaced between a series of joint notches along a workpiece 28 suitable for the formation of Kumiko lattice grids as well as other designs.

The conventional table saw 11 has a saw blade 11A projecting above the saw tabletop 11C. Two miter tracks 18 are formed in the saw tabletop 11C and located parallel with the saw blade 11A, one on the left and one on the right thereof. The table saw 11 provides a guide fence 11B running from the front of the tabletop 11C (typically the side nearest the operator) to the back, parallel to the cutting plane/blade path of the saw blade 11A. The guide fence 11B can be used in guiding a workpiece during the process of making a rip cut.

The table saw sled 10 provides a substrate 30 for sliding along the saw tabletop 11C. The substrate 30 has an upper surface 31 and a lower surface 32. Along the lower surface 32 one or more runners 16 are provided to operatively associate with the one or more miter tracks 18 of said saw tabletop 11C.

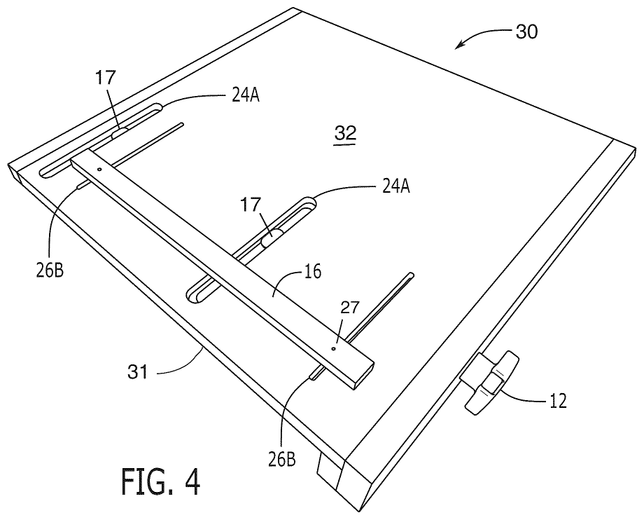

Referring to FIG. 4, the table saw sled 10 has two spaced apart runner adjustment tracks 26B formed through the substrate 30, communicating the upper surface 31 with the lower surface 32. A runner 16 extends longitudinally along the lower surface 32, from near the front of the substrate 30 to near the back thereof. The runner 16 is operatively associated with each runner adjustment track 26B by way of an adjustable fasteners 27 so that the runner 16 is selectively adjustable laterally along the lower surface 32, whereby the runner 16 can be selectively disposed along the lower surface to associate with the miter track 18 of the table saw 11, wherever that miter track 18 may be located along any given saw tabletop 11C. A user may selectively move the runner 16 laterally by loosening and then tightening or otherwise manipulating the adjustable fasteners 27. Accordingly, the runner 16 and thus the table saw sled 10 can be accommodated by various table saws 11 having their miter tracks 18 fixed at different locations relative to the respective saw blade 11A.

Referring the FIGS. 1 through 3, spaced apart from each runner adjustment track 26B may be an angled key adjustment track 26A, also formed through the substrate 30 so that each angled key adjustment track 26A communicates the upper surface 31 with the lower surface 32. An angled guide shuttle 55 may provide two couplers 17 along its bottom surface that operatively associated with the two angled key adjustment track 26A so that the angled guide shuttle 55 is selectively movable laterally along the upper surface 31 by way of the user manipulating adjustment knobs 12 accessible along the upper surface 31.

Fixed to a blade-facing peripheral edge 59 of the angled guide shuttle 55 is an angled registration key 15. The angled registration key 15 may be a planar elongated rectangular member that at least provides a straight edge that projects above an upper surface of the guide shuttle 55. Since the angled registration key 15 is fixed to the angled guide shuttle 55, and the latter is laterally movable, so too is the angled registration key 15 selectively laterally movable.

Spaced apart from the angled registration key 15, on the other side of a longitudinal axis associated with the table saw blade 11A, are two angled guide blocks 22. Each angled guide block 22 defines a guide plane 29 oriented at an acute angle relative to the longitudinal axis associated with the table saw blade 11A, i.e., the blade path. Accordingly, a workpiece 28 retained, flush, against the angled guide plane 29 of an angled guide block 22 will cross the path of the table saw blade 11A at said acute angle, whereby cuts made by said table saw blade 11A define an angled joint notch in that workpiece 28, say a first angled joint notch 51. When the workpiece 28 is moved along the angled guide plane 29, the first angled joint notch 51 can be seated on the angled registration key 15 so that a second angled joint notch 52 may be cut into the workpiece 28 at a spacing determined by the fixed location of the angle registration key relative to the blade path or blade channel 13. Each angled guide block 22 is critically recessed in a groove along a portion of the upper surface 31 (or a built-up element between the upper surface 31 and the angled guide blocks 22).

Projecting orthogonally above the upper surface 31 is a front sled fence 23 running laterally from the left to right of the table saw sled 10. Critically, the front sled fence 23 is attached along the front edge of the substrate 30 so that the front sled fence 23 is more accurately fixed to and squared relative to the upper surface 31 of the substrate 30. The criticality is further demonstrated because the front sled fence 23 provides a rectangular key adjustment track 24A for a rectangular registration key 14. The rectangular registration key 14 is indirectly ridable along said rectangular key adjustment track 24A so that a user may selectively move the rectangular registration key 14 laterally along the upper surface 31 of the substrate 30, and in turn the user selectively defines the reference distance between said rectangular registration key 14 and the blade path.

The rectangular registration key 14 is operatively associated with a rectangular guide shuttle 44, whereby the rectangular guide shuttle 44 provides a coupler that directly rides along said rectangular key adjustment track 24A, wherein the lockable engagement of aid fastener can be manipulated by way of an adjustment knob 12 (viewable in FIG. 4). The coupler is accessible through an aperture 46 along the rectangular guide shuttle 44.

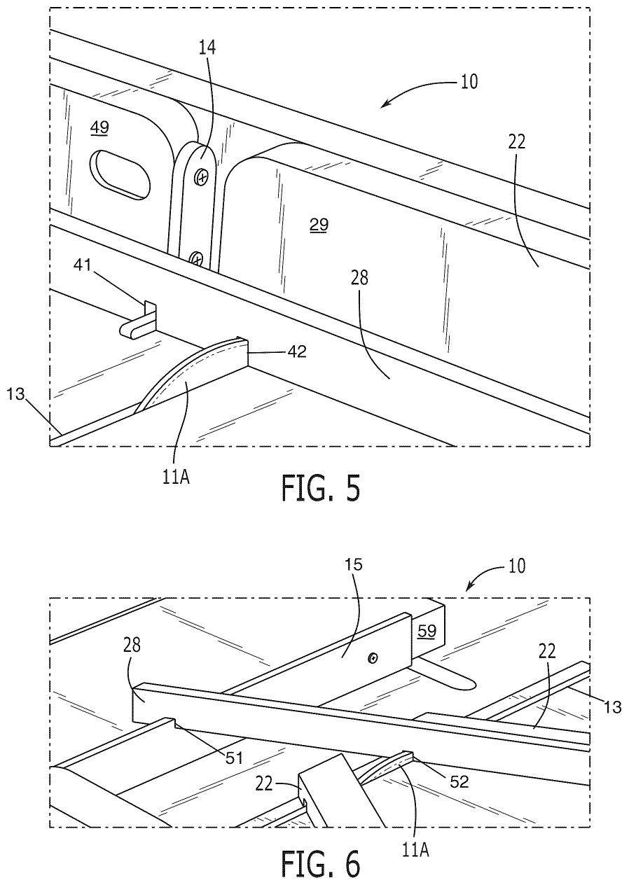

Along front sled fence 23, on the other side of the blade path 13, a rectangular guide block 22 is fixed to the front sled fence 23. The guide block 22 provides a rectangular guide plane 29 for workpieces 28 to be retained against in a flush manner, as illustrated in FIG. 5. The rectangular guide plane 29 has a coplanar arrangement with a supporting surface 49 of the rectangular guide shuttle 44. Accordingly, a workpiece can be simultaneously retained against the rectangular guide plane 29 and the supporting surface 49 of the rectangular guide shuttle 44 as the workpiece spans the blade path. Thus, a user may cut a first rectangular joint notch 41 into a workpiece 28 (that is retained against the rectangular guide plane 29) with the saw blade 11A, and then reposition said workpiece 28 so the first rectangular joint notch 41 engages/sits on the rectangular registration key 14 so that a second rectangular joint notch 42 can be cut into the workpiece 28 that is simultaneously retained against the rectangular guide plane 29 and said supporting surface 49. Thereby, the user consistently cuts orthogonal, rectangular (cross section) joint notches along the workpiece 28 at an interval that matches the reference distance established when the user sets the rectangular guide shuttle 44 via the rectangular key adjustment track 24A.

A rear edge 34 of the substrate 30 provides a centering guide 20 for guiding the saw blade 11A of the table saw 11 along the blade path or blade channel 13. The centering guide 20 allows the user to align the center of the sled to the saw blade. This is used when initially adjusting the runner

The keys may be made of metallic or various plasticized material, while the other elements may be from high-quality wood products. The substrate needs to be cut very accurately with various grooves at different angles. The metal keys then need to be cut and milled to an exact thickness and shape. All the parts need to be attached together in a specific order and orientation.

In operation, the table saw sled 10 is placed on a table saw 11 with the runner 16 of the table saw sled 10 operatively associated with the miter track 18 of the table saw 11 to act as a sliding-miter table or sled. The table saw sled 10 knobs and couplers and adjustable fasteners are loosened to adjust the registration keys 14 and 15 by way of their respective guide shuttles 44 and 55. The couplers 17 may be bolts slidable in the respective key adjustment tracks 24A of the substrate 30 and the front sled fence 23 to set the registration keys 15 and 14 depending on a desired spacing between joint notches. The adjustment knobs 12 are then tightened on the bolts/couplers 17 to lock the position of the registration keys 14 and 15, thereby defining a reference distance between the key 14/15 and the blade path, and so defining the spacing of a series of notches to be cut into a workpiece 28.

The operator then places strips of wood (lattices) or Kumiko workpiece 28 against the guide blocks 22 and pushes the table saw sled 10 over the table saw blade 11A making a small cut in the Kumiko workpiece 28. That cut is then placed over the adjacent registration key and the process is repeated for the desired grid size and shape. Accordingly, the present invention can make lattice type wooden grids for Kumiko woodwork.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A table saw sled for repeatedly cutting notches of a predetermined size and at a predetermined interval along a workpiece, the table saw sled comprising:
a substrate having an upper surface and an opposing lower surface;
two runner adjustment slots formed in the substrate so that each runner adjustment slot communicate the upper surface with the lower surface while extending laterally along the substrate; and
a runner spanning the two runner adjustment slots adjacent the lower surface so that at each interface of the runner and the two runner adjustment slots a coupler slidably associates an end of the runner with a respective runner adjustment slot,
whereby the runner is laterally movable along the lower surface so as to adjust relative to a fixed miter track of a table saw the table saw sled operatively associates with.

2. The table saw sled of claim 1, further comprising:
two angle key adjustment tracks formed in the substrate so that each angle key adjustment tracks communicate the upper surface with the lower surface while extending laterally along the substrate;
an angle guide shuttle operatively associated with the two angle key adjustment tracks so that the angle guide shuttle is selectively movable laterally along the upper surface of the substrate;
an angle registration key fixed to the angle guide shuttle so that the angle registration key faces a blade path of the table saw; and
two angle guide blocks disposed along the upper surface of the substrate on the other side of the blade path, wherein the two angle guide blocks are nested in two grooves, respectively, along said upper surface,
whereby an angle reference distance, between the angle registration key and the blade path, is selectively lockable.

3. The table saw sled of claim 2, further comprising:
a front guide fence joined to a front edge of the substrate so that a substantially portion of the front guide fence projects above the upper surface thereof;
a rectangle key adjustment track formed laterally in the substantial portion;
a rectangle guide shuttle slidably associated with the rectangle key adjustment track; and
a rectangle registration key fixed relative to a shuttle guide plane of rectangle guide shuttle so that the rectangle registration key is selectively lockable laterally along the front guide fence,
whereby a rectangle reference distance, between the rectangle registration key and the blade path, is selectively lockable.

4. The table saw sled of claim 3, further comprising a rectangle guide block fixed to the front guide fence, wherein the rectangle guide block provides a block guide surface coplanar with the shuttle guide plane.
